(19) United States
(12) Patent Application Publication
(10) Pub. No.: US 2024/0246060 A1
(43) Pub. Date: Jul. 25, 2024

(54) Method Of Manufacture And Scale-Up Of The Metal-Organic Framework Cu(Qc)2

(71) Applicant: ExxonMobil Technology and Engineering Company, Annandale, NJ (US)

(72) Inventors: Carter W. Abney, Athens, WI (US); Julie J. Seo, Clinton, NJ (US); Matthew T. Kapelewski, Lambertville, NJ (US); Dominick A. Zurlo, Easton, PA (US); Joseph M. Falkowski, Hampton, NJ (US)

(21) Appl. No.: 18/561,619

(22) PCT Filed: May 20, 2022
(86) PCT No.: PCT/US2022/030183

§ 371 Date: Nov. 16, 2023

Related U.S. Application Data
(60) Provisional application No. 63/191,579, filed on May 21, 2021.

(51) Int. Cl. B01J 20/22; B01D 53/02; B01J 20/30

(52) U.S. Cl. CPC B01J 20/226; B01D 53/02; B01J 20/3078; B01D 2253/204; B01D 2257/7022

(57) ABSTRACT

Methods of making metal-organic frameworks in yields of at least about 50 percent by volume of metal-organic frameworks in a metal-organic framework material per liter of synthesis solution and/or about 75 molar percent of metal-organic frameworks in a metal-organic framework material are provided. Methods of making MOF Cu(Qc)2 in aqueous solutions are further provided where a solvent composition of less than about 30% volume water is combined with a buffer and a plurality of reagents to provide the synthesis solution.

### CROSS REFERENCE TO RELATED APPLICATIONS

The present application claims priority to and the benefit of U.S. Provisional Application No. 63/191,579 filed on May 21, 2021, which is hereby incorporated by reference in its entirety.

### FIELD

The present disclosure generally relates to methods of making metal-organic frameworks to provide increased yield and higher molar percent of metal-organic frameworks in a metal-organic framework material, and more specifically increased yield and higher molar percent relates to MOF Cu(Qc)₂ as an ethane-selective adsorbent for gas separation.

### BACKGROUND

Metal-Organic Frameworks (“MOFs”) are materials comprised of metals and multi-topic organic linkers that self-assemble to form a coordination network. MOFs can have various uses for different applications including gas storage, gas separation, catalysis, sensing, and environmental remediation. By adjusting pore size and through the use of inorganic linkers that offer strong electrostatics, new selectively benchmarks have been realized. Sometimes molecular sieving cannot be achieved because it is difficult to control pore size within the 3 to 4 angstrom range, most relative to gas molecule separation. Even when pore size is shown to be adjustable, the reaction synthesis yields can be very low. Therefore, the metal-organic framework (“MOF”) material cannot be produced in large quantities suitable for commercial scale up.

### SUMMARY

Provided herein are methods which provide yields of at least about 50 percent by volume of metal-organic frameworks in a metal-organic framework material per liter of synthesis solution. The methods of making the metal-organic frameworks comprise mixing ethanol, at least one solvent, an acetate metal salt and quinoline-5-carboxylic acid to provide a synthesis solution. The at least one solvent is an organic solvent. The synthesis solution is non-aqueous having a concentration of at least 0.04 to 0.4 moles of quinolone-5-carboxylic acid per liter of the synthesis solution. The synthesis solution is heated to a reaction temperature. The reaction temperature is reduced to produce the metal-organic framework material having a volumetric yield of at least about 50 percent by volume of metal-organic frameworks. In an aspect, the concentration of the acetate metal salt in the synthesis solution is between about 0.16 and about 0.24 mole per liter of solvent. In an aspect, the metal-organic frameworks have a solvent inclusion between about 9.0 to about 12.7 percent by volume. In an aspect, the synthesis solution is heated for at least about 24 to about 72 hours. In an aspect, the reaction temperature is reduced at a rate of between about 0.1 to about 10° C. per hour. In an aspect, the metal-organic framework material comprises MOF Cu(Qc)₂. In an aspect, the MOF Cu(Qc)₂ has adsorption maxima (λmax) at a wavelength of about 474 nanometers.

Also provided herein are methods yielding about 75 molar percent of metal-organic frameworks in a metal-organic framework material. These methods of making the metal-organic frameworks at 75 molar percent comprise providing a solvent composition comprising at least one solvent. The solvent composition is combined with a plurality of solid reagents to provide a synthesis solution. The synthesis solution is heated to a reaction temperature of at least 80° C. or above. The reaction temperature is reduced to produce a metal-organic framework material where 75 molar percent of the metal-organic framework material are metal-organic frameworks. The plurality of solid reagents comprises an acetate metal salt and of at least 0.04 to 0.4 moles of quinolone-5-carboxylic acid per liter of the synthesis solution. In an aspect, the solvent composition is non-aqueous. In an aspect, the solvent is selected from dimethylformamide and/or tetrahydrofuran. In an aspect, the metal-organic frameworks have a solvent inclusion between about 9.0 to about 12.7 percent by volume. In an aspect, the metal-organic frameworks have a solvent inclusion between about 9.0 to about 12.7 percent by volume. In an aspect, the synthesis solution is heated for at least about 24 to about 72 hours. In an aspect, the reaction temperature is reduced at a rate of between about 0.1 to about 10° C. per hour. In an aspect, the metal-organic framework material comprises MOF Cu(Qc)₂. In an aspect, the MOF Cu(Qc)₂ has adsorption maxima (λmax) at a wavelength of about 474 nanometers.

Further provided are methods of producing a 75 molar percent yield of metal-organic frameworks per liter of a synthesis solution. In these methods, ethanol, an acetate metal salt and quinoline-5-carboxylic acid are mixed to provide a synthesis solution. The synthesis solution is heated to a reaction temperature. The reaction temperature is reduced to produce a metal-organic framework material comprising a 75 molar percent yield of metal-organic frameworks per liter of synthesis solution. In these methods, the synthesis solution is non-aqueous and has a concentration of at least 0.04 to 0.4 moles of quinolone-5-carboxylic acid per liter of the synthesis solution. In an aspect, the synthesis solution is heated for at least about 24 to about 72 hours. In an aspect, the reaction temperature is reduced at a rate of between about 0.1° C. to about 10° C. per hour. In an aspect, the metal-organic framework material comprises MOF Cu(Qc)₂. In an aspect, the MOF Cu(Qc)₂ has adsorption maxima (max) at a wavelength of about 474 nanometers.

Further provided is a metal-organic framework, MOF Cu(Qc)₂, having an adsorption maxima (λmax) at a wavelength of about 474 nanometers, and a solvent inclusion between about 9.0 to about 12.7 percent by volume. The metal-organic framework is made by a process comprising the steps of mixing ethanol, dimethylformamide, copper acetate hydrate, and quinoline-5-carboxylic acid to provide a synthesis solution. The synthesis solution has a concentration of about 0.04 moles of quinolone-5-carboxylic acid per liter of synthesis solution. The synthesis solution is heated to a reaction temperature of at least 80° C. and the reaction temperature is reduced to produce a metal-organic framework material having at least 75 molar percent metal-organic frameworks MOF Cu(Qc)₂.

Methods of making MOF Cu(Qc)₂ in aqueous solutions are also provided. These methods comprise a solvent composition of less than about 30% volume water. The solvent composition is combined with a buffer and a plurality of reagents to provide a synthesis solution. The synthesis solution is heated to a reaction temperature of at least 80° ° C. or above for at least 4 hours to produce MOF Cu(Qc)₂. The reagents include one or more metal salts and one or more linkers. In an aspect, the metal salt is acetate metal. In an aspect, the linker is 5-carboxyquinoline. In an aspect, the buffer comprises a morpholine and a sulphonic acid bridged by an alkyl group. In an aspect, the buffer comprises a Brønsted acid and its conjugate base, or a Brønsted base and its conjugate acid. In an aspect, the buffer is a bicarbonate or sodium carbonate. In an aspect, the buffer is MOPS, Na MOPS or NaHCO₃. In an aspect, the solvent composition is selected by evaluation of Hansen solubility parameters.

These and other features and attributes of the disclosed . . . of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a graph providing the results of a thermogravimetric analysis of synthesized MOF Cu(Qc)₂ where 9 to 12.7% solvent inclusion was shown.

FIG. 2A, FIG. 2B, FIG. 2C and FIG. 2D show the powder x-ray diffraction patterns of the present materials synthesized.

FIG. 3 is a SEM image taken at 3.0 kV 8.8 mm ×2.00 k SE(L) of MOF Cu(Qc)₂ materials (crystals) of synthesized with the present methods in Run 1.

FIG. 4 is a SEM image taken at 3.0 KV 8.8 mm ×400 SE(L) of MOF Cu(Qc)₂ materials synthesized with the present methods in Run 1.

FIG. 5 is a SEM image taken at 3.0 kV 8.7 mm ×10.0 k SE(L) of MOF Cu(Qc)₂ materials synthesized with the present methods in Run 1.

FIG. 6 is a SEM image taken at 3.0 kV 8.7 mm ×2.00 k SE(L) of MOF Cu(Qc)₂ materials synthesized with the present methods in Run 1.

FIG. 7 is a SEM image taken at 3.0 kV 8.7 mm ×400 SE(L) of MOF Cu(Qc)₂ materials synthesized with the present methods in Run 1.

FIG. 8 shows adsorption maxima in dashed vertical lines and UV-Vis of MOF Cu(Qc)₂ materials made with prior art synthesis as well as materials made with the present methods.

FIG. 9 shows CO₂ adsorption isotherms at 195° K for MOF Cu(Qc)₂ synthesized with Cu(OAc)₂ at the 600 mL and 2 L scales.

FIG. 10 shows CO₂ adsorption data at 195° K for MOF Cu(Qc)₂ materials of Example 1

FIG. 11 shows the powder x-ray diffraction pattern of MOF Cu(Qc)₂ synthesized with alternative solvents (other than dimethylformamide).

FIG. 12 is a SEM image taken at 3.0 kV 8.4 mm ×10.0 k SE(L) of comparative MOF Cu(Qc)₂ materials synthesized with prior art methods.

FIG. 13 is a SEM image taken at 3.0 kV 8.4 mm ×2.00 k SE(L) of comparative MOF Cu(Qc)₂ materials synthesized with prior art methods.

FIG. 14 is a SEM image taken at 3.0 kV 8.4 mm ×2.00 k SE(L) of comparative MOF Cu(Qc)₂ materials synthesized with prior art methods.

FIG. 15 is a SEM image taken at 3.0 kV 8.5 mm ×2.00 k SE(L) of comparative MOF Cu(Qc)₂ materials synthesized with prior art methods.

FIG. 16 is a SEM image taken at 3.0 kV 8.5 mm ×400 k SE(L) of comparative MOF Cu(Qc)₂ materials synthesized with prior art methods.

FIG. 17 shows the powder x-ray diffraction patterns of MOF Cu(Qc)₂ materials synthesized with the different solvent compositions of Example 3.

FIG. 18 shows the powder x-ray diffraction patterns of MOF Cu(Qc)₂ materials synthesized with aqueous solvent compositions including buffers at a concentration of 1.25 equivalents relative to the sum of the organic linker and metal.

FIG. 19 is a graph showing thermogravimetric analysis of MOF Cu(Qc)₂ materials synthesized with aqueous solvent compositions of Runs −11, −12, −13 and −14 of Example 3.

FIG. 20A and FIG. 20B are SEM images taken at 2.0 kV 13.4 mm ×4.50 k SE(L) and 2.0 kV 13.4 mm ×3.50 k SE(L) of MOF Cu(Qc)₂ materials (crystals) of Run −11 of Example 3.

FIG. 21A and FIG. 21B are SEM images taken at 2.0 kV 13.2 mm ×22.0 k SE(L) and 2.0 kV 13.2 mm ×4.50 k SE(L) of MOF Cu(Qc)₂ materials of Run −12 of Example 3.

FIG. 22A and FIG. 22B are SEM images taken at 2.0 kV 13.1 mm ×20.0 k SE(L) and 2.0 kV 13.1 mm ×4.50 k SE(L) of MOF Cu(Qc)₂ materials of Run −13 of Example 3.

FIG. 23A and FIG. 23B are SEM images taken at 2.0 kV 13.1 mm ×10.0 k SE(L) and 2.0 kV 13.1 mm ×5.00 k SE(L) of MOF Cu(Qc)₂ materials of Run −14 of Example 3.

FIG. 24 shows the powder x-ray diffraction pattern of MOF Cu(Qc)₂ materials of Run −1 and Run −2 of Example 3 which were made by an acetone/water synthesis.

FIG. 25 is a graph showing thermogravimetric analysis of Mass Cu(BF₄)₂ 6H₂O for various temperatures in the acetone/water synthesis of Run −1 and Run −2 of Example 3.

FIG. 26A and FIG. 26B are SEM images taken at 2.0 kV 13.6 mm ×19.2 k SE(L) and 2.0 kV 13.6 mm ×5.00 k SE(L) of MOF Cu(Qc)₂ materials of Run −1 of Example 3.

FIG. 27A and FIG. 27B are SEM images taken at 2.0 kV 13.3 mm ×25.0 k SE(L) and 2.0 kV 13.3 mm ×4.50 k SE(L) MOF Cu(Qc)₂ materials of Run −2 of Example 3.

### DETAILED DESCRIPTION

Before the present methods and devices are disclosed and described, it is to be understood that unless otherwise indicated this disclosure is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

For the purposes of this disclosure, the following definitions will apply:

As used herein, the terms “a” and “the” as used herein are understood to encompass the plural as well as the singular.

As used herein, the term “Periodic Table” means the Periodic Table of the Elements of the International Union of Pure and Applied Chemistry (IUPAC), dated December 2015.

As used herein, an “isotherm” refers to the adsorption of an adsorbate as function of concentration while the temperature of the system is held constant.

The term “salt(s)” includes salts of the compounds prepared by the neutralization of acids or bases, depending on the particular ligands or substituents found on the compounds described herein. When compounds of the present disclosure contain relatively acidic functionalities, base addition salts can be obtained by contacting the neutral form of such compounds with a sufficient amount of the desired base, either neat or in a suitable inert solvent. Examples of base addition salts include sodium, potassium, calcium, ammonium, organic amino, or magnesium salt, or a similar salt. Examples of acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids, and the like, as well as the salts derived from relatively nontoxic organic acids like acetic, propionic, isobutyric, butyric, maleic, malic, malonic, benzoic, succinic, suberic, fumaric, lactic, mandelic, phthalic, benzenesulfonic, p-tolylsulfonic, citric, tartaric, methanesulfonic, and the like. Certain specific compounds of the present disclosure contain both basic and acidic functionalities that allow the compounds to be converted into either base or acid addition salts. Hydrates of the salts are also included.

The term “solvent” means and includes the system used to dissolve molecules, forming a solution, the major component of a solution, with the dissolved molecules comprising the minor component or solute.

The term “reagent” means and includes a molecule, compound, or mixture which is added to a system to cause a chemical reaction or to test whether a reaction has occurred which may or may not be consumed or transformed in the course of the reaction.

The term “Hansen solubility parameters” refers to the separation of any molecule's cohesive energy density into three components approximating the dispersion forces, permanent dipole-permanent dipole forces, and molecular hydrogen bonding forces. The similarity of respective Hansen solubility parameters between two different molecules suggests a high likelihood of solubility. Conversely, molecules with markedly different Hansen solubility parameters are not likely to be soluble. A complete and thorough definition and explanation is provided in “Hansen Solubility Parameters: A User's Handbook, 2^{nd} Ed.,” by Charles M. Hansen.

The term “Powder X-ray Diffraction” or PXRD refers to a scientific technique where the diffraction of x-rays is used to provide structural characterization of a material. Atoms in a material which are ordered symmetrically and with a regular periodicity will result in constructive interference of scattered x-rays where the path length difference is an integer multiple of the wavelength, producing diffraction maxima in accordance with Bragg's law.

It is understood that, in any compound described herein having one or more chiral centers, if an absolute stereochemistry is not expressly indicated, then each center may independently be of R-configuration or S-configuration or a mixture thereof. Thus, the compounds provided herein can be enantiomerically pure or be stereoisomeric mixtures. In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the subject compounds, whether radioactive or not, are intended to be encompassed within the scope of present disclosure.

All numerical values within the detailed description and the claims herein are intended to modified by “about” or “approximately” the indicated value, and take into account experimental error and variations that would be expected by a person of ordinary skill in the art.

A metal-organic framework (“MOF” or in the plural “MOFs”) is a material comprised of both metals and multi-topic organic linkers that self-assemble to form a coordination network. As used herein, a “metal organic framework” can be a mixed-metal organic framework or a metal-organic framework system or a mixed-metal mixed-organic framework system as described in U.S. Patent Application No. 62/839,261.

MOFs have wide-ranging potential uses in many different applications including gas storage, gas separation, catalysis, sensing, and environmental remediation. The metal-organic framework, MOF Cu(Qc)₂ (Qc is quinolone-5-carboxylate) has potential application in the separation of olefins from paraffins, and specifically ethane from ethylene.

Ethane and ethylene are light hydrocarbons used as chemical raw materials in petrochemical industry. Separation and recovery of these molecules from natural gas was traditionally performed by using cryogenic distillation, a high energy-consuming process. Recently, adsorption has been found to be an effective alternative separation process. Adsorption can operate at room temperature, leading to substantial energy savings. The adsorbent, however, must be effective and stable. Metal-organic frameworks have been found to be effective. Further, metal-organic frameworks can offer high adsorption rates at relatively low cost. However, metal-organic frameworks can have a slightly lower selectively compared to cryogenic distillation, and there are problems with stability.

With respect to gas adsorption for the petroleum industry, metal-organic frameworks are divided into two categories: ethylene-selective adsorbents and ethane-selective adsorbents. For commercial applications, use of ethane-selective adsorbents to separate ethylene from classical crack gas (C₂H₆/C₂H₄ 1:12-15 volume:volume) are often more effective than ethylene-selective adsorbents, especially to produce polymer-grade ethylene with purity of 99.8%. Ethane-selective adsorbents typically require only one cycle of adsorption process to obtain polymer-grade ethylene. Liang et al., 2018. These ethane-selective MOF adsorbents include the metal-organic framework Cu(Qc)₂ (“MOF Cu(Qc)₂”) See, Chen et al., Tuning Pore Size in Square-Lattice Coordination Networks for Size Selective Sieving of CO₂, Chem. Int. Ed., 55, 10268-10272, 2016; Lin et al., Ethane Ethylene Separation in a Metal Organic Framework With Iron-Peroxo Sites, Science 362, 2018. MOF Cu(Qc)₂ preferentially adsorbs ethane over ethylene through the interaction of van der Waals. Among other ethane-selective MOFs, MOF Cu(Qc)₂ has high selectivity of ethane from natural gas (“NG”) due to its ultra-microporous structure with molecular dimension.

As described by Chen et al., supra. 2016, to generate metal-organic framework materials, reticular chemistry can be used to control over pore dimensions and molecular chemistry in a manner that is difficult to achieve in other classes of porous materials. In hybrid ultra-microporous materials, pore-size can be achieved through short organic linkers. Further, molecules with kinetic diameters larger than the pore molecular sieving can be excluded, enabling ultra-high selectivity while allowing passage of smaller molecules. Unfortunately, molecular sieving is difficult to achieve for gas molecule separations because pore-size within the 3 to 4 angstroms (“Å”) range can be a challenge to control. Furthermore, an observed large uptake difference at low temperature could be an artifact of pore contraction, slower gas diffusion rates or reduced thermal motion. Indeed, these dynamics are unwanted in sieving materials as they could induce a gate-opening effect and lost sieving ability.

Also as reported by Chen et al. supra. 2016, only a handful of molecular sieves for CO₂ over CH₄ and/or N₂ at or near ambient conditions are known. In several of these examples, uncharacterized activated structures account for observed molecular sieving. Coordination networks invariably exhibit preference towards CO₂ over N₂ and/or CH₄ because of weak adsorbate-adsorbent interactions.

Notwithstanding, Chen et al. supra. 2016 report that fine-tuning of pore-size enables supramolecular isomerism, that is, the generation of networks with the same chemical composition, but with different topology. Exemplary are the five coordination networks of formula [M(quinoline-5-carboxylate)₂]ₙ, Qc-5-M-dia (M=Co, Ni, Zn and Cu, dia=2-fold, 3D diamondoid network) and Qc-5-Cu-sql-α (sql=2D square lattice network) which were synthesized solvothermally from quinoline-5-carboxylic acid and the respective metal salts.

Further Qc-5-M-die and Qc-5-Cu-sol-α were found to be supramolecular isomers. The materials were then studied by single-component gas sorption, dynamic breakthrough of gas mixtures, temperature-programmed desorption (“TPD”), and molecular modeling. In the process Qc-5-Cu-sql-α undergoes an irreversible phase change upon desolvation to Qc-5-Cu-sql-β, a more stable polymorph of Qc-5-Cu-sql-α. The b-phase does not revert back to the a-phase even after attempted re-solvation, heating or soaking in water for 21 days. Interestingly, Qc-5-Cu-sql-β adsorbs moderate quantities of CO₂ at 293 K and 1 atm, but little CH₄ or N₂ under the same conditions, suggesting a sieving effect. Qc-5-M-dia crystallizes as 2-fold interpenetrated dia networks in tetragonal space groups whereas Qc-5-Cu-sql-α crystallizes in the monoclinic space group P2₁/c. The coordination geometry around the metal cations is distorted octahedral: each metal is coordinated to four oxygen atoms (from two carboxylate groups) and two nitrogen atoms (from two quinoline rings). Different orientations of the linker ligand enable supramolecular isomerism to occur in Qc-5-Cu. Qc-5-Cu-dia and Qc-5-Cu-sql-α exhibit 1D channels with diameters of 4.8 Å and 3.8 Å, respectively, and network void spaces of 34.7% and 23.5%, respectively.

As promising as these reports appear, MOF Cu(Qc)₂ currently faces the challenge of high cost to produce and/or water vapor instability which must be addressed before these metal-organic frameworks can be put into commercial application. Simplistic, rapid synthesis of MOFs without performance loss are needed. To further reduce the cost of the MOF Cu(Qc)₂, different synthesis have been investigated. Further, post-synthesis or pre-synthesis modifications have been proposed to enhance the water vapor stability of MOFs without performance loss. For example, facile room-temperature synthesis of copper-based Cu(Qc)₂ has been examined for its performance for separation of ethane/ethylene and recovery of ethane from natural gas. Tang. Y. et al., Room Temperature Synthesis of Cu(Qc)₂ and its Application for Ethane Capture from Light Hydrocarbons, Chem. Eng. Sci., 213, 2020. Prior to the discovery of the present methods, this material was made only in small quantities.

The present methods offer several advancements in making metal-organic framework materials and metal-organic frameworks including: (1) changes in synthetic conditions (including a different metal salt) to make metal-organic framework materials having different crystallite morphology and CO₂ capacity than previous versions: (2) changes in concentration of synthesis to increase volumetric yield of the metal-organic framework produced; and (3) scale-up of synthesis of the metal-organic framework to larger scales (as a result of the other changes in synthetic conditions).

### Traditional Synthesis

Traditionally, metal-organic frameworks are prepared by reactions of pre-synthesized or commercially available linkers with metal ions. An alternative approach, referred to as “in situ linker synthesis,” specified organic linkers (linkers) can be generated in the reaction media in situ from the starting materials. In synthesizing the metal-organic framework, organic molecules are not only structure-directing agents but as reactants to be incorporated as part of the framework structure. With this in mind, elevated reaction temperatures are generally employed in conventional synthesis. Solvothermal reaction conditions, structure-directing agents, mineralizers as well as microwave-assisted synthesis or steam-assisted conversions have also been recently introduced.

As referred to herein, a traditional synthesis is typically applied reactions carried out by conventional electric heating without any parallel reactions. In the traditional synthesis, reaction temperature is a primary parameter of a synthesis of the metal-organic framework and two temperature ranges, solvothermal and nonsolvothermal, are normally distinguished, which dictate the kind of reaction setups to be used. Solvothermal reactions generally take place in closed vessels under autogenous pressure about the boiling point of the solvent used. Nonsolvothermal reactions take place below, or at the boiling point under ambient pressure, simplifying synthetic requirements. Nonsolvothermal reactions can be further classified as room-temperature or elevated temperatures.

The traditional synthesis of metal-organic frameworks takes place in a solvent and at temperatures ranging from room temperature to approximately 250° C. Heat is transferred from a hot source, the oven, through convection. Alternatively, energy can be introduced through an electric potential, electromagnetic radiation, mechanical waves (ultrasound), or mechanically. The energy source is closely related to the duration, pressure, and energy per molecule that is introduced into a system, and each of these parameters can have a strong influence on the metal-organic framework formed and its morphology.

As described herein, original synthesis of making MOF Cu(Qc)₂ included solvothermal method in which high temperature (105° C.) and long reaction time (48 hours) were required. Chen et al., 2016. Five coordination networks of formula [M(quinoline-5-carboxylate)₂]ₙ, Qc-5-M-dia (M=Co, Ni, Zn and Cu, dia=2-fold, 3D diamondoid network) and Qc-5-Cu-sql-α (sql=2D square lattice network), were synthesized solvothermally from HQc (quinoline-5-carboxylic acid) and the respective metal salts.

However, since this time, room temperature synthesis of MOF Cu(Qc)₂, have been recently developed. See e.g., Tang. Y. et al., supra. 2020. Here. ZnO (23.49 mg. 0.29 mmol) and Cu(BF₄)₂·6H₂O aqueous solution (0.44 g. 0.58 mmol) were dispersed in 12 mL ethanol and sonicated for 10 minutes at ambient temperature to get (Zn. Cu) hydroxy double salt [(Zn. Cu)(OH)BF₄], an intermediate solution. Then DMF solution (12 mL) of HQc (0.10 g. 0.58 mmol) was added. At the same time, the mixture was stirred and a synthesis reaction was carried out for one to twelve hours. After that. RT-Cu(Qc)₂ was collected as purple powder by filtration, then washed by DMF and soaked in ethanol for 1 day. Samples were dried at 393 K for 8 hours in vacuum. Addition of ZnO into Cu(BF₄)₂·6H₂O solution was found to be important for promoting room-temperature synthesis of Cu(Qc)₂. ZnO and Cu(BF₄)₂ in the solution would form (Zn, Cu) hydroxyl double salt as intermediate, reportedly having excellent anion exchangeability (Zhao et al., 2015; Li et al., 2017; Wu et al., 2019), and the fast exchange among OH⁻ and BF₄⁻ from the [(Zn, Cu)(OH)BF₄] and Qc⁻ was promoted at ambient condition.

### Present Methods of Making Metal Organic Frameworks

The present methods are directed to synthesizing large amounts of a metal-organic framework MOF Cu(Qc)₂ and for subsequent use of the same in an adsorptive separation applications, particularly separation of ethane and ethylene. The MOF Cu(Qc)₂ material has prospective uses in other separation applications as well owing to its small pore size.

MOF Cu(Qc)₂ produced with present methods have been shown to be a useful in the adsorptive separation of ethane/ethylene mixtures. The present methods provide improved synthesis of metal-organic framework material at scale, with properties differing from those of the originally reported synthesis in the literature. Acetate metal salt can be used to produce metal-organic framework material of comparable/improved quality compared to material previously synthesized. The change in metal salt allows for a significant increase in concentration, which improves volumetric yields of product with no loss in quality. Different crystal size and morphology are shown compared to the lower concentration/different metal salt synthesis. Changes to the metal-organic framework material are shown, for example in the UV-Vis spectrum.

As further described in the examples below, the present methods of making metal-organic frameworks can yield at least about 50 percent by volume of metal-organic frameworks in metal-organic framework material per liter of synthesis solution. The present methods include mixing ethanol, at least one solvent, an acetate metal salt and quinoline-5-carboxylic acid to provide a synthesis solution. In this particular methodology, the solvent is an organic solvent. The synthesis solution is non-aqueous having a concentration of at least 0.04 to 0.4 moles of quinolone-5-carboxylic acid per liter of the synthesis solution. The synthesis solution is heated to a reaction temperature. The reaction temperature is reduced to produce metal-organic framework material having a volumetric yield of at least about 50 percent by volume of metal-organic frameworks.

In accordance with various aspects of this methodology, concentration of the acetate metal salt in the synthesis solution is between about 0.16 and about 0.24 mole per liter of solvent. Further, the metal-organic frameworks can have a solvent inclusion between about 9.0 to about 12.7 percent by volume. In aspect, the synthesis solution is heated for at least about 24 to about 72 hours. In an aspect, the reaction temperature is reduced at a rate of between about 0.1 to about 10° C. per hour. In an aspect, the metal-organic framework material is MOF Cu(Qc)₂. In an aspect, the MOF Cu(Qc)₂ has adsorption maxima (λmax) at a wavelength of about 474 nanometers.

Also provided herein are methods of producing about 75 molar percent yield of metal-organic frameworks in a metal-organic framework material. These methods of making the metal-organic frameworks use a solvent composition having at least one solvent. The solvent composition is combined with a plurality of solid reagents to generate a synthesis solution. The synthesis solution is heated to a reaction temperature of at least 80° C. or above. The reaction temperature is reduced a metal-organic framework material is produced where about 75 molar percent of the metal-organic framework material is metal-organic frameworks. This methodology uses a plurality of solid reagents including an acetate metal salt and at least 0.04 to 0.4 moles of quinolone-5-carboxylic acid per liter of the synthesis solution. In an aspect, the solvent composition is non-aqueous. In an aspect, the solvent is selected from dimethylformamide and/or tetrahydrofuran. In an aspect, the metal-organic frameworks have a solvent inclusion between about 9.0 to about 12.7 percent by volume. In an aspect, the metal-organic frameworks have a solvent inclusion between about 9.0 to about 12.7 percent by volume. In an aspect, the synthesis solution is heated for at least about 24 to about 72 hours. In an aspect, the reaction temperature is reduced at a rate of between about 0.1 to about 10° C. per hour. In an aspect, the metal-organic framework material comprises MOF Cu(Qc)₂. In an aspect, the MOF Cu(Qc)₂ has adsorption maxima (Δmax) at a wavelength of about 474 nanometers.

The present methods can also provide a 75 molar percent yield of metal-organic frameworks per liter of synthesis solution. Here, ethanol, an acetate metal salt and quinoline-5-carboxylic acid are mixed to provide a synthesis solution. The synthesis solution is non-aqueous and has a concentration of at least 0.04 to 0.4 moles of quinolone-5-carboxylic acid per liter of the synthesis solution. The synthesis solution is heated to a reaction temperature. The reaction temperature is reduced to produce a metal-organic framework material comprising a 75 molar percent yield of metal-organic frameworks per liter of synthesis solution. In an aspect, the synthesis solution is heated for at least about 24 to about 72 hours. In an aspect, the reaction temperature is reduced at a rate of between about 0.1 to about 10° C. per hour. In an aspect, the metal-organic framework material comprises MOF Cu(Qc)₂. In an aspect, the MOF Cu(Qc)₂ has adsorption maxima (λmax) at a wavelength of about 474 nanometers.

Further provided here are metal-organic frameworks, MOF Cu(Qc)₂, having an adsorption maxima (λmax) at a wavelength of about 474 nanometers, and a solvent inclusion between about 9.0 to about 12.7 percent by volume. This metal-organic framework is made by a process comprising the steps of mixing ethanol, dimethylformamide, copper acetate hydrate, and quinoline-5-carboxylic acid to provide a synthesis solution. To produce the MOF Cu(Qc)₂, the synthesis solution has a concentration of about 0.04 moles of quinolone-5-carboxylic acid per liter of synthesis solution and is heated to a reaction temperature of at least 80° C. The reaction temperature is then reduced producing a metal-organic framework material comprising at least 75 molar percent metal-organic frameworks MOF Cu(Qc)₂.

As further described in the examples, alternative novel methods of making MOF Cu(Qc)₂ using an aqueous solution are provided herein. In these methodologies, a solvent composition is combined with a buffer and a plurality of reagents to provide a synthesis solution. The reagents include one or more metal salts and one or more linkers. The solvent composition is less than about 30% volume water. In an aspect of this methodology, the solvent composition can be selected by evaluation of Hansen solubility parameters. In an aspect, the solvent composition comprises water and acetone. The synthesis solution is heated to a reaction temperature of at least 85° C. or above for at least 4 hours to produce MOF Cu(Qc)₂. In an aspect, the synthesis solution can be heated in static, tumbling or stirred conditions.

Furthermore, according to an embodiment of this methodology, the metal salt is acetate metal and the linker is 5-carboxyquinoline. Materials made with acetate salt have been shown to have the same structure and the same, if not greater surface area and separation performance. The buffer can be a morpholine and a sulphonic acid bridged by an alkyl group. The buffer can be a Brønsted acid and its conjugate base, or a Brønsted base and its conjugate acid. Further, the buffer can be a bicarbonate or sodium carbonate such as MOPS, Na MOPS or NaHCO₃.

According to an embodiment of any one of the present methods provided herein, the MOF Cu(Qc)₂ can have a particle size between about 0.5 microns to about 755 microns. Further, in an aspect, the MOF Cu(Qc)₂ can have a BET surface area of about 200 to about 300 m²/gram. In an aspect, the MOF Cu(Qc)₂ has a CO₂ capacity of between about 40 and about 90 cubic centimeters per gram at 0.5 bar and 195° K. As also provided by the methods described herein, the MOF Cu(Qc)₂ can have a CO₂ capacity of between about 60 cubic centimeters per gram at 0.5 bar and 195° K. In an aspect, MOF Cu(Qc)₂ can have an ethane adsorption capacity of between about 1.8 and about 2.6 millimole per gram at 303° K. In an aspect, MOF Cu(Qc)₂ has an ethane adsorption capacity of between about 2.0 and about 2.4.

Any one of the present methods described herein can further comprising a step of filtering the metal-organic framework material. In addition, the methods can include optional steps of washing the metal-organic framework material and/or triturating the metal-organic framework material. Filtering, washing and triturating can be repeated at least once.

Moreover, any one of the present methods described herein can provide a metal-organic framework that produces powder x-ray diffraction peaks at 20 values between about 10° and about 15° and between about 25° and about 30° for the metal-organic framework Cu(Qc)₂ dried. Further, the present methods can produce the MOF Cu(Qc)₂ having powder x-ray diffraction peaks at 20 values which are equal to a metal-organic framework Cu(Qc)₂ produced by a traditional synthesis.

Synthesis of the metal-organic framework materials at scale can provide metal-organic frameworks having different properties from the original synthesis reported in the literature. MOF Cu(Qc)₂ has been shown to be useful in the adsorptive separation of ethane/ethylene mixtures. The present methods use acetate metal salt or similar metal salts to produce metal-organic framework materials of comparable/improved quality compared to those previously synthesized. In our experimentation described below, we have found that an acetate metal salts allow for a significant increase in concentration, which improves volumetric yields of the metal-organic framework product without loss in quality. Further, different crystal sizes and morphology compared to the lower concentration/different metal salt synthesis, as well as changes to the material itself, for example in the UV-Vis spectrum have been uncovered.

The present methods enhance metal-organic framework materials and synthesis of making the same. First, modifications in the synthetic conditions (including a different metal salt) provide metal-organic frameworks having different crystallite morphology making the material adaptable to CO₂ capacities where unavailable in prior art versions. Second, adjustments in concentration of reaction synthesis in order to increase volumetric yield. Third, as a result of other alterations in synthetic conditions, the scale-up of reaction synthesis makes the production of the metal-organic framework material to larger scales possible.

The present methods increase yield amounts of MOF Cu(Qc)₂ (where Qc is quinolone-5-carboxylate), testing of the same and subsequent use of the MOF in a adsorptive separation application, ethane/ethylene. This material has prospective uses in other separation applications as well owing to its small pore size.

### Examples

The features of the invention are described in the following non-limiting examples.

### Example 1: Increasing Process Yield and Adsorption Capacity

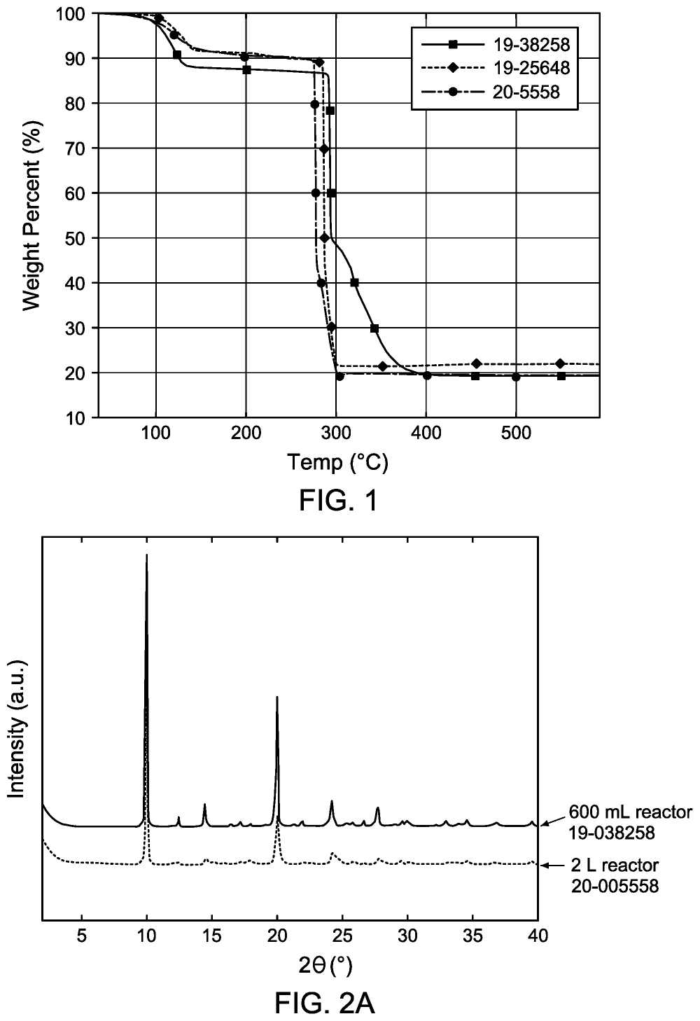

Two reactions were undertaken using the present methodologies. In one reaction, MOF Cu(Qc)₂ was synthesized by mixing 240 milliliter (“mL”) ethanol, 240 mL dimethylformamide. 8.40 grams (“g”) copper acetate hydrate [Cu(OAc)₂·xH₂O], and 16.0 g Quinoline-5-carboxylic acid to a 600 mL stainless steel autoclave. The reactor was sealed, stirred at 250 rpm, and heated to a reaction temperature of 105° C. for 72 hours (“h”). The synthesis solution was cooled at a rate of 6° C. per hour under stirring, then opened when the synthesis solution reached room temperature. The metal-organic framework material was filtered and a purple solid recovered. The metal-organic framework material was washed with 300 mL dimethylformamide, 300 mL ethanol, and then triturated in 600 mL dimethylformamide while stirring at 60° ° C. filtered, triturated in 600 mL ethanol at 60° C. in ethanol for 3 hours, filtered, triturated in 600 mL methanol at 60° C. for 12 hours, and filtered to obtain 13.13 gram of a purple powder. As shown in FIG. 1, thermogravimetric analysis (“TGA”) showed that this powder contained 12.7% solvent, leading to a final Cu(Qc)₂ yield of 11.46 g (61%). Other samples had as little as 9 to 10% solvent as well.

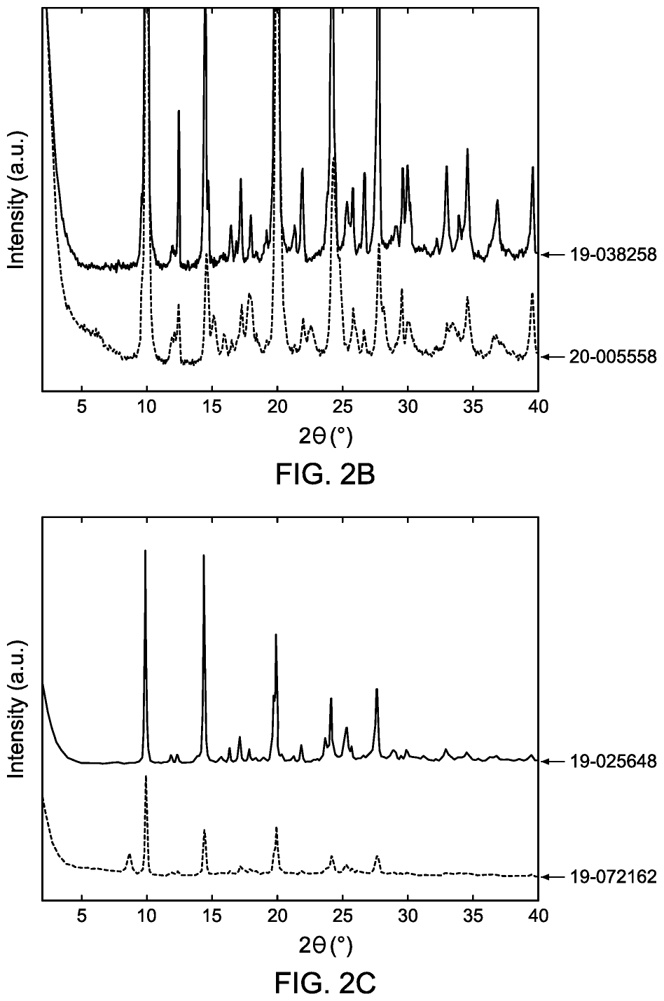

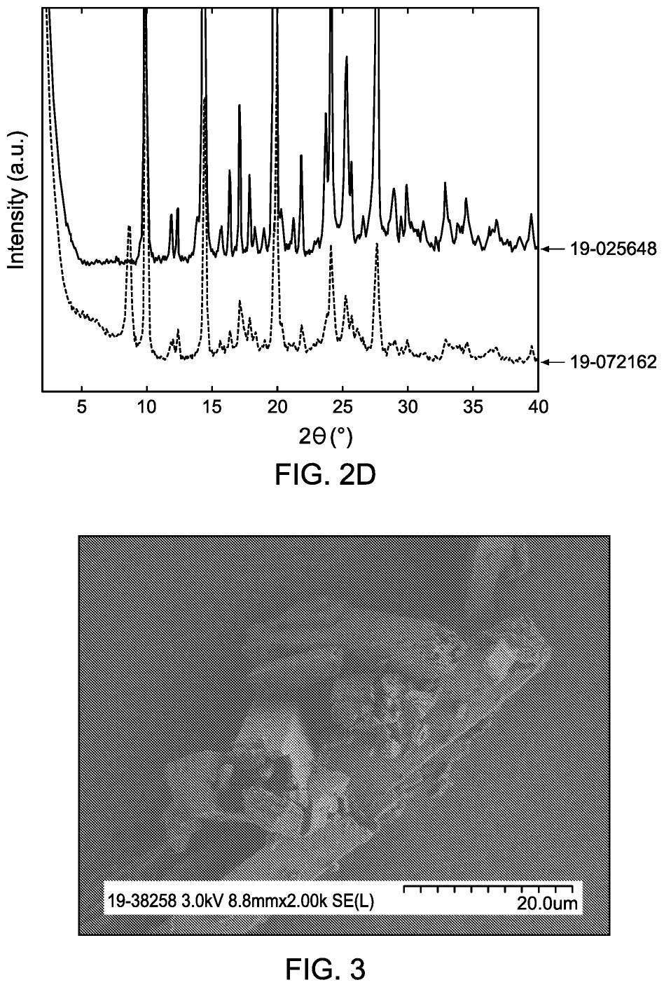

At a larger scale. Cu(Qc)₂ was synthesized by mixing 800 mL ethanol. 800 mL dimethylformamide. 28.0 g copper acetate hydrate [Cu(OAc)₂·xH₂O], and 53.33 grams of quinoline-5-carboxylic acid to a 2 liters (“L”) stainless steel autoclave (in that order) equipped with a paddle overhead stirrer. The reactor was sealed, stirred at 250 rpm, and heated to a reaction temperature of 105° C. for 72 hours. The synthesis solution was cooled at a rate of 6° C./h under stirring, then opened when it reached room temperature. The metal-organic framework material was filtered to recover a purple solid. This solid was washed with 300 mL dimethylformamide. 300 mL ethanol, and then triturated in 600 mL dimethylformamide while stirring at 60° C. filtered, triturated in 600 mL ethanol at 60° C. in ethanol for 3 hours, filtered, triturated in 600 mL methanol at 60° C. for 12 hours, and filtered to obtain 48.6 grams (after excluding calculated solvent in the pores as measured by thermogravimetric analysis) of a purple powder. Powder x-ray diffraction patterns of the materials synthesized are shown in FIG. 2A, FIG. 2B, FIG. 2C, and FIG. 2D.

The present methodologies differ from prior art methods in several notable ways as summarized in Table 1. The Cu salt has been changed from Cu(BF₄)₂ or Cu(BF₄)₂·6H₂O used in prior art methods to Cu(OAc)₂·xH₂O. Additionally, the concentration of the metal increased from 0.024 mol/L Cu to 0.096 mol/L Cu.

TABLE 1

| | | | | Cu Salt | Qc | |
|---|---|---|---|---|---|---|
| | EtOH | DMF | | amount | amount | |
| Sample | (mL) | (mL) | Cu Salt | (mol) | (mol) | MIDAS |
| 1 | 240 | 240 | Cu(OAc)₂•xH₂O | 0.0462 | 0.0924 | 19-38258 |
| | | | | (anhydrous | | |
| | | | | basis) | | |
| 2 | 800 | 800 | Cu(OAc)₂•xH₂O | 0.154 | 0.308 | 20-5558 |
| | | | | (anhydrous | | |
| | | | | basis) | | |
| 3 | 240 | 240 | Cu(BF₄)₂•xH₂O | 0.0462 | 0.0924 | 19-25648 |
| 4 | 240 | 240 | Cu(OAc)₂•xH₂O | 0.0924 | 0.185 | 19-72162 |
| 5 | 240 | 240 | Cu(OAc)₂•xH₂O | 0.0462 | 0.0924 | 19-72163 |
| Comparative | 2 | 2 | Cu(BF₄)₂ | 0.0001 | 0.0002 | |
| 1 | | | | | | |
| Comparative | 6 | 6 | Cu(BF₄)₂•6H₂O | 0.00029 | 0.00058 | |
| 2 | | | | | | |

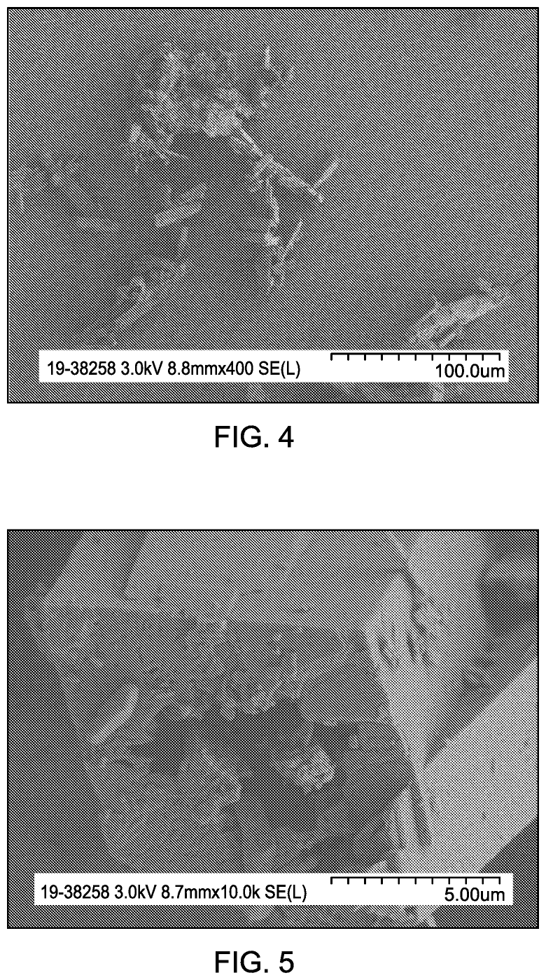

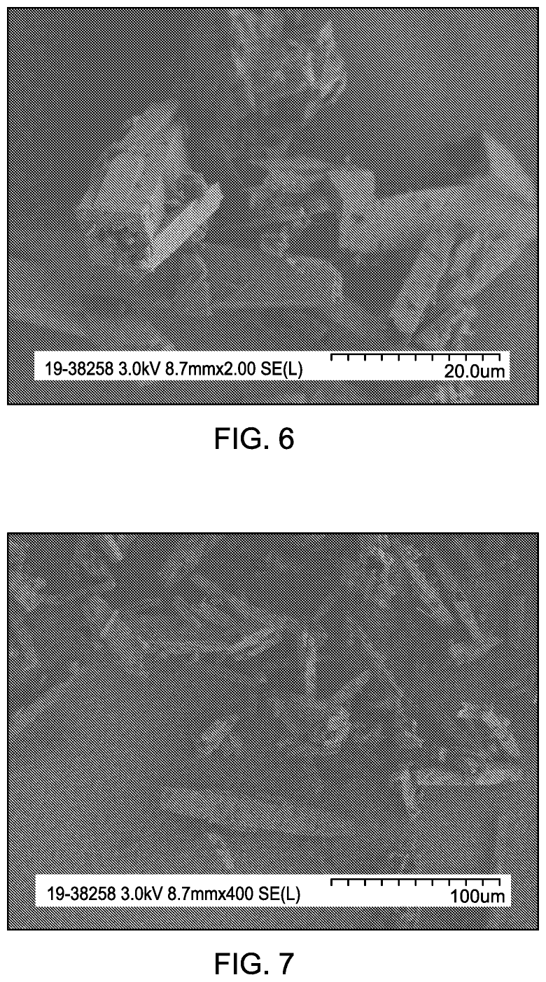

As shown in FIG. 3 through FIG. 7, the morphology of the crystallites produced in this synthesis is crucial to determining how to formulate the material. To that end, SEM images of the crystallites were obtained. As shown in FIG. 3, FIG. 4, FIG. 5 and FIG. 6, square prismatic rods from 10 microns to 150 microns were observed, with smaller dimensions in the square dimensions as compared to the long dimension.

CO₂ adsorption properties were measured at 195 K, which can be used to determine the surface area of the material and be used as a proxy for determining the capacity for ethane/ethylene separations. The MOF Cu(Qc)₂ produced was determined to have a CO₂ capacity of 2.30 mmol/g at 1 bar. The BET surface area determined from this CO₂ adsorption was 229 m²/g and the pore volume was 0.10 cm³/g.

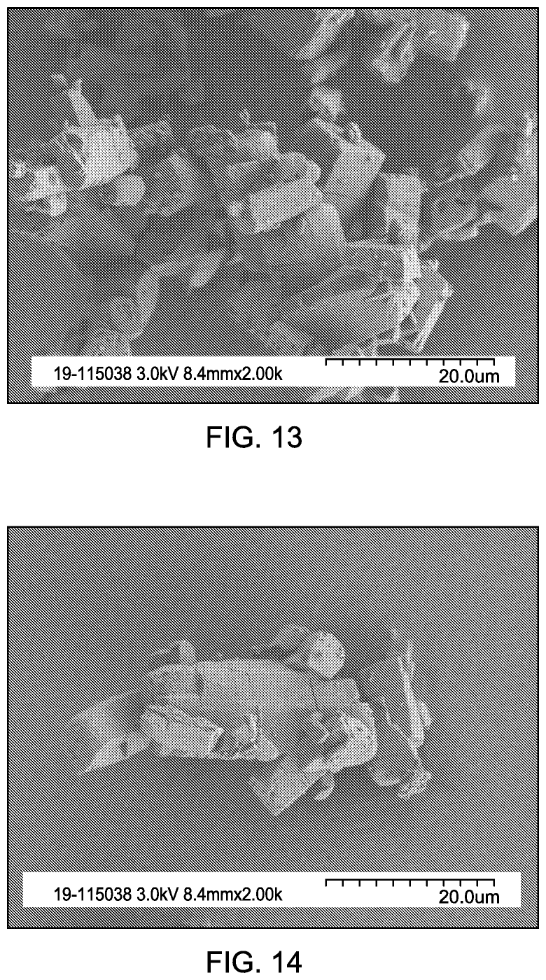

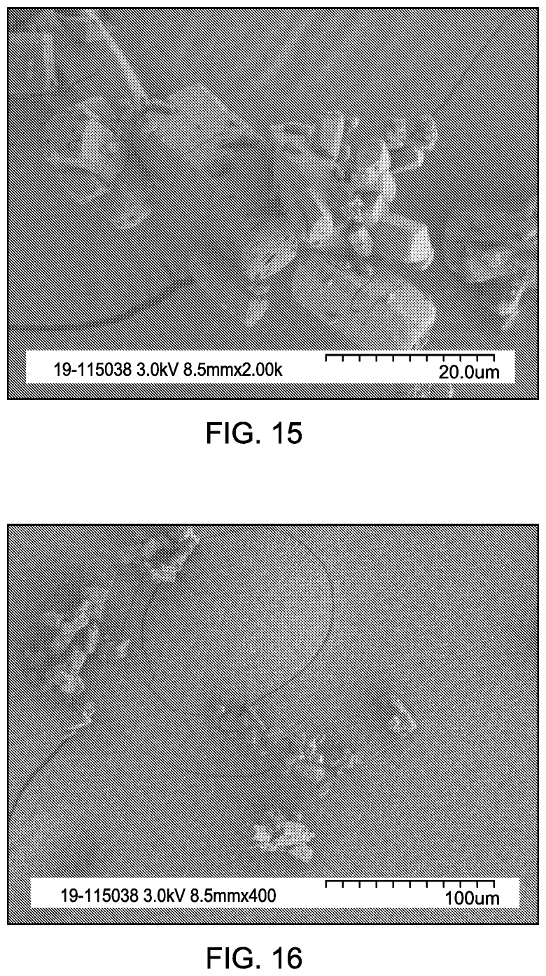

As a point of comparison, synthesis described by Chen, K. et al., Tuning Pore Size in Square-Lattice Coordination Networks for Size-Selective Sieving of CO₂, Angew. Chem. Int. Ed., 55, 10268-10272, 2018. (Comparative 1), and by Lin, W. et al., Boosting Ethane Ethylene Separation within Isoreticular Ultramicroporous Metal-Organic Frameworks, J. Am. Chem. Soc., 140, 12940-12946, 2018. (Comparative 2) were recreated to compare with the data from the synthesis of the present methodologies. FIG. 12 through FIG. 16 are the SEM images of comparative MOF Cu(Qc)₂ materials synthesized with prior art methods. As shown in Table 2 below, significantly different particle sizes were demonstrated, with the present synthesis having an order of magnitude higher particle sizes on average, while also having a significantly larger (more polydisperse) range of particle sizes as compared to prior art samples.

TABLE 2

| | Prior Art Sample | Present Synthesis |
|---|---|---|
| | (19-115038) | (20-005558) |
| Mean particle size (microns) | 14.293 | 303.970 |
| Median particle size D50 (microns) | 14.453 | 226.461 |
| Mode of particle size (microns) | 16.193 | 555.706 |
| D10 particle size (microns) | 4.747 | 2.476 |
| D90 particle size (microns) | 22.612 | 753.080 |
| Sample or Comparative | Comparative | Sample |

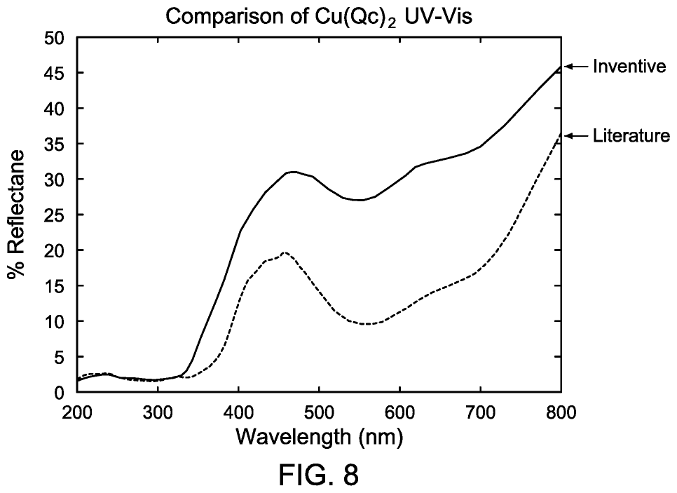

Additionally, as shown in FIG. 8, the different materials exhibit color differences, as seen through UV-Vis spectroscopy. The other materials exhibit a maximum absorption at 458 nm. As shown in FIG. 8, metal-organic framework materials produced with the present methods exhibit a maximum absorption at 474 nm.

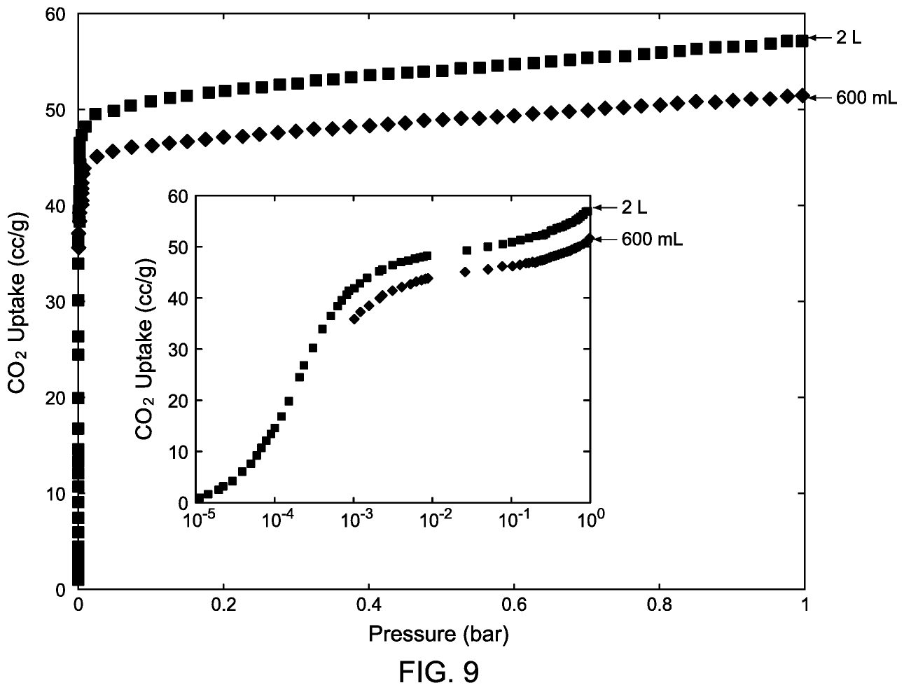

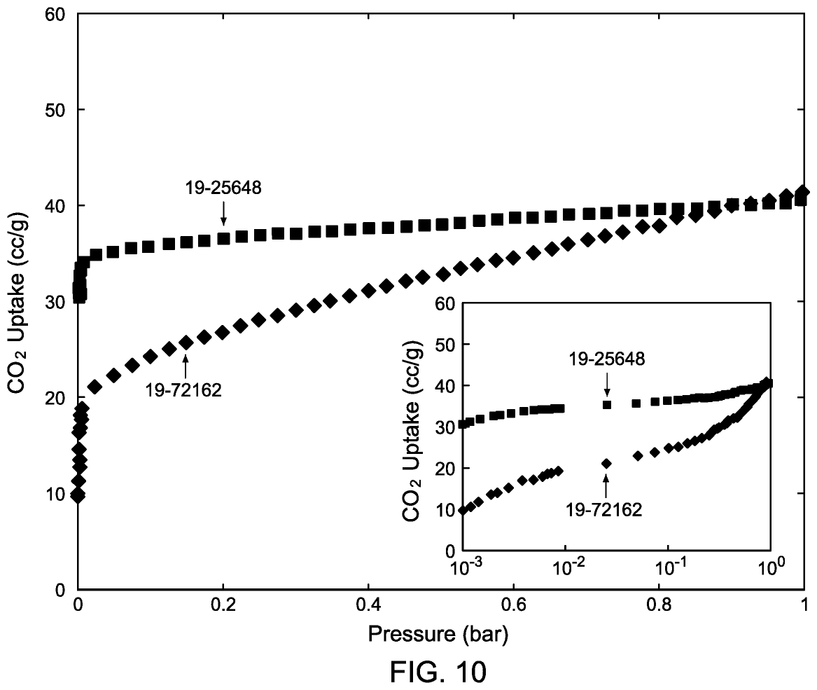

As shown in FIG. 9 and FIG. 10, CO₂ uptake at 195 K was measured for several of these samples to determine the overall porosity off the materials (as they are not porous to N₂ at 77 K, which is typically what is used to measure surface area of materials). CO₂ capacities for the metal-organic framework materials are higher than those seen in the literature demonstrating a superior material with a higher surface area. See e.g., Tengjiao, H. et al., Ultramicroporous Metal-Organic Framework Qc-5-Cu for Highly Selective Adsorption of CO₂ from C₂H₄ Stream, Ind. Eng. Chem. Res. 59, 7, 3153-3161, 2020.

### Example 2: Alternative Solvent Compositions to Produce MOF Cu(Qc)2

MOF Cu(Qc)₂ was synthesized in an alternative solvent composition intended to replace the toxic dimethylformamide in the traditional synthesis. The reaction parameters are shown in Table 3 below.

TABLE 3

| | | | | Cu Salt | Qc |
|---|---|---|---|---|---|
| THF | ACN | Water | | amount | amount |
| (mL) | (mL) | (mL) | Cu Salt | (mol) | (mol) |
| 240 | 120 | 120 | Cu(OAc)₂•xH₂O | 0.014 | 0.028 |
| | | | | (anhydrous | |
| | | | | basis) | |

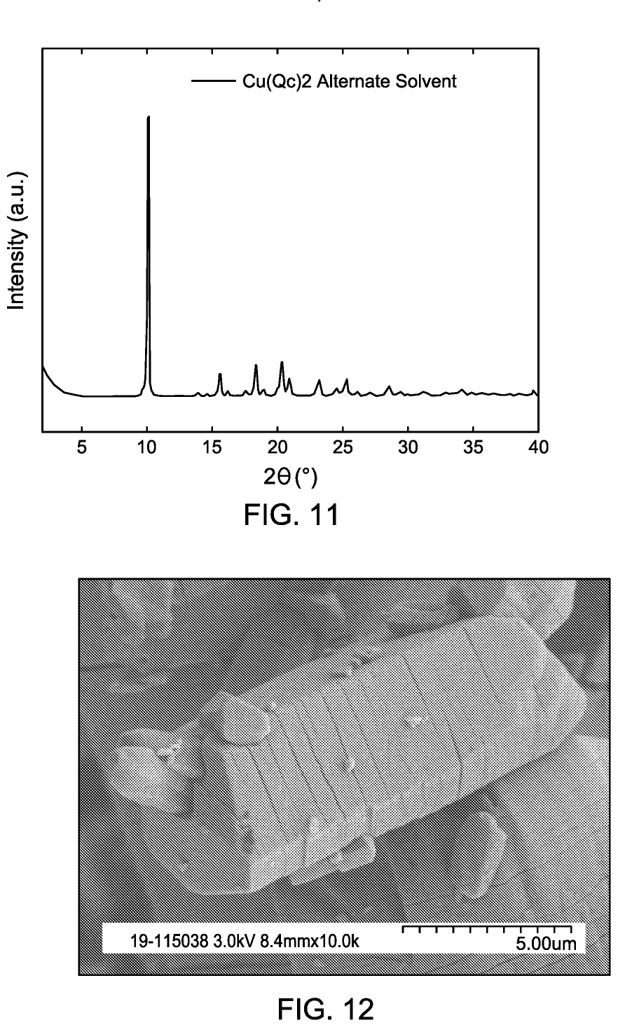

The alternative solvent composition produced MOF Cu(Qc)₂ according the power X-ray diffraction pattern of FIG. 11. The present methods of making MOF Cu(Qc)₂ are quite practical in that toxic and hazardous dimethylformamide are replaced with more benign and possibly less expensive solvents.

### Example 3: Producing MOF Cu(Qc)₂ in Aqueous Solvent Compositions

Methods of making MOF Cu(Qc)₂ without the use of polar aprotic solvents are described in this Example. As described herein, the traditional syntheses of making the metal-organic frameworks typically involve the use of hazardous and expensive polar aprotic solvents, most notably dimethylformamide (“DMF”). By leveraging Hansen Solubility Parameters and affording pH matching through incorporation of inexpensive commodity buffers, alternate solvent formulations (“solvent compositions”) do not require the hazardous and/or expensive polar aprotic solvents. The resulting methods are water/acetone systems having a sodium carbonate/sodium bicarbonate buffer, to reduce the cost from preparing the metal-organic framework in DMF and/or with other polar aprotic solvents.

We used the traditional synthesis of MOF Cu(Qc)₂ as follows: 500 mg of 5-carboxyquinoline (CAS 7250-53-5) and 500 mg of Cu(BF₄)₂ (MIDAS 18-084608-0; CAS 15684-35-2) and mix it in 30 mL of a 1:1 DMF/methanol solution. The synthesis solution was then heated to 105° C. overnight. Reagents are combined in round bottom flask and refluxed with jacketed-condenser.

Consideration of the Hansen Solubility Parameters for a 1:1 DMF/methanol solution affords a range of different options. The preparation articulated above was repeated, substituting the aforementioned solvent compositions for DMF/methanol. The solvent compositions are described in Table 4 below. One synthesis was attempted at 85° C. The traditional synthesis to make MOF Cu(Qc)₂ was performed in DMF/MeOH at 105° C. as a control.

TABLE 4

| Number | Solvent Composition | pH |
|---|---|---|
| −1 | 41% MeOH, 11% Water, 21% MeCN, 27% | 9.15 |
| | Pyridine | |
| −2 | 43% Acetone, 27% Water, 16% MeCN, 14% | 8.85 |
| | Pyridine | |
| −3 | 61% Acetone, 28% Water, 11% Pyridine | 8.72 |
| −4 | 37% THF, 26% Water, 36% MeCN | 8.86 |
| −5* (85° C.) | 62% MeOH, 19% MeCN, 19% Pyridine | 9.05 |
| control | 50% MeOH, 50% DMF | 9.35 |

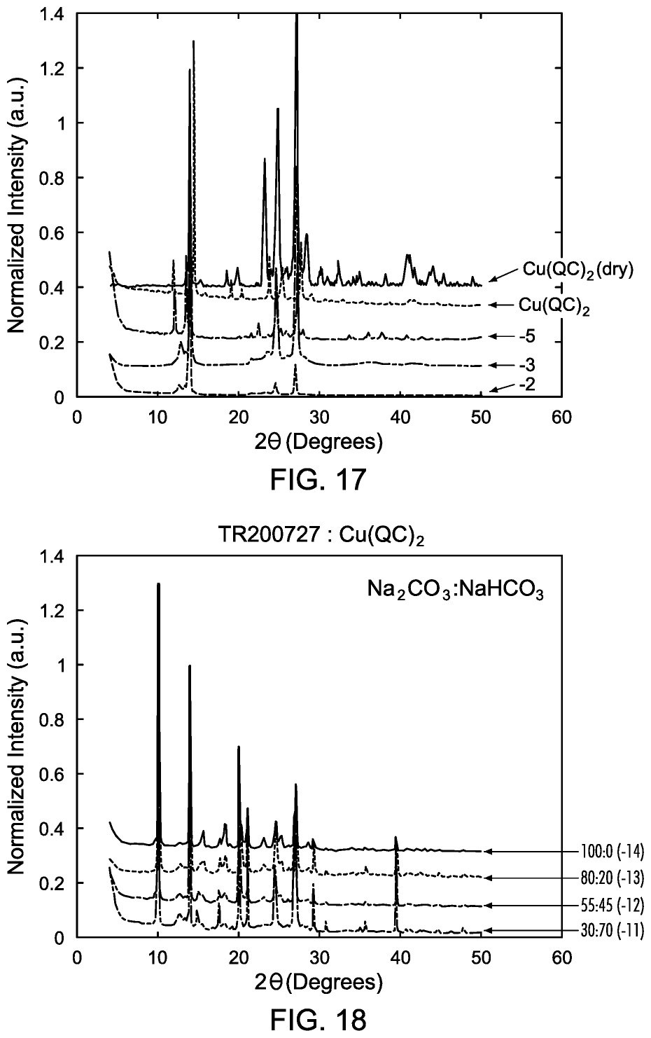

FIG. 17 displays powder x-ray diffraction (“PXRD”) data from these syntheses. The Cu(Qc)₂ control is different from what was expected. Similar peaks to the control were observed for the materials synthesized in the surrogate solvents.

While known to play a role in MOF syntheses, pH was not controlled in the syntheses described in Table 4. This could be a rationale for why the solvent compositions performed poorly. However, this did not provide insight to the outcome of the control experiment.

Therefore, subsequent experiments included weak acid/base pairs (i.e., buffers) in an effort to control that aspect of the synthesis and achieve the intended phase. The behavior of buffers is dictated through the identity of the solvent in which they are dissolved. Most buffers are known only for aqueous solutions. Thus, for the additional syntheses shown in Table 5 below, a minimum volume fraction of water was set at 25%.

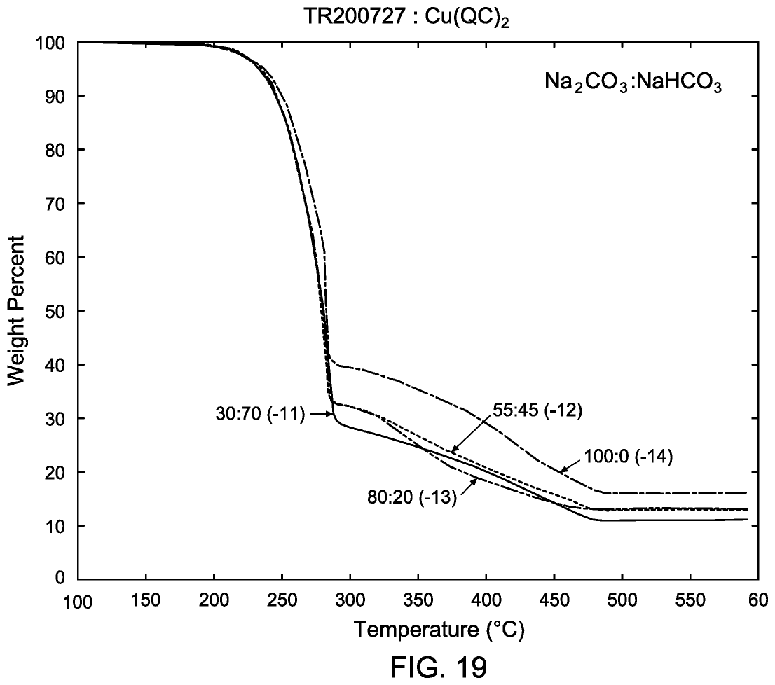

One solvent composition, identified as 25% water, 5% n-Propanol, 33% tetrahydrofuran, 37% acetonitrile (Table 5) and another identified as 73% acetone, 27% water (Table 6) were explored as MOF Cu(Qc)₂ synthesis. The synthesis included buffers at concentrations of 1.25 equivalents (“eq”) relative to the sum of the organic linker and metal. FIGS. 18 and 19 show PXRD data for the compositions described in Table 5.

TABLE 5

| | | | pH | pH |
|---|---|---|---|---|
| Run | Solvent Composition | Na₂CO₃:NaHCO₃ | (theo) | (exp no L) |
| −11 | 25% Water, 5% n-PrOH, | 30:70 | 9.5 | 11.49 |
| | 33% THF, 37% MeCN | | | |
| −12 | 25% Water, 5% n-PrOH, | 55:45 | 10 | 11.85 |
| | 33% THF, 37% MeCN | | | |
| −13 | 25% Water, 5% n-PrOH, | 80:20 | 10.5 | 12.35 |
| | 33% THF, 37% MeCN | | | |
| −14 | 25% Water, 5% n-PrOH, | 100:0 | 11 | 12.72 |
| | 33% THF, 37% MeCN | | | |

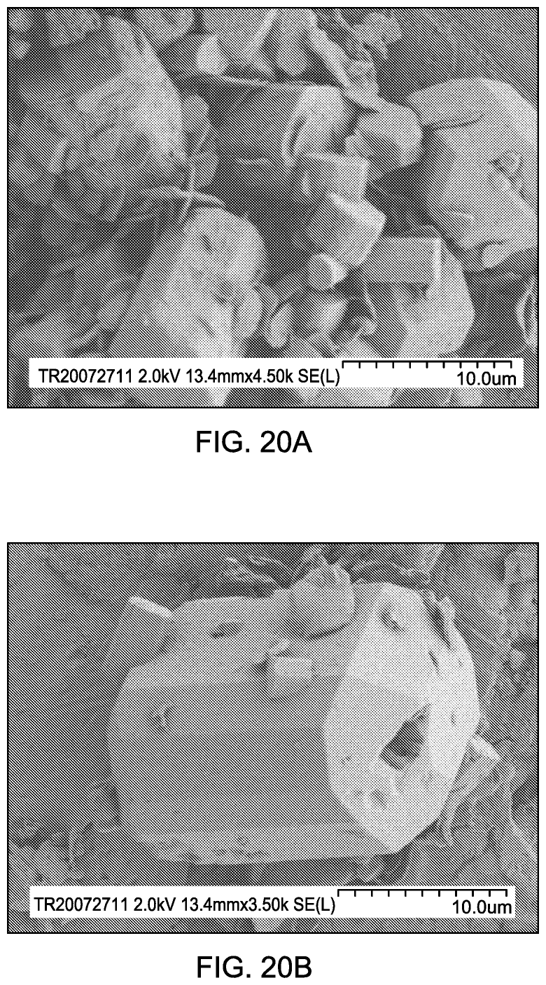

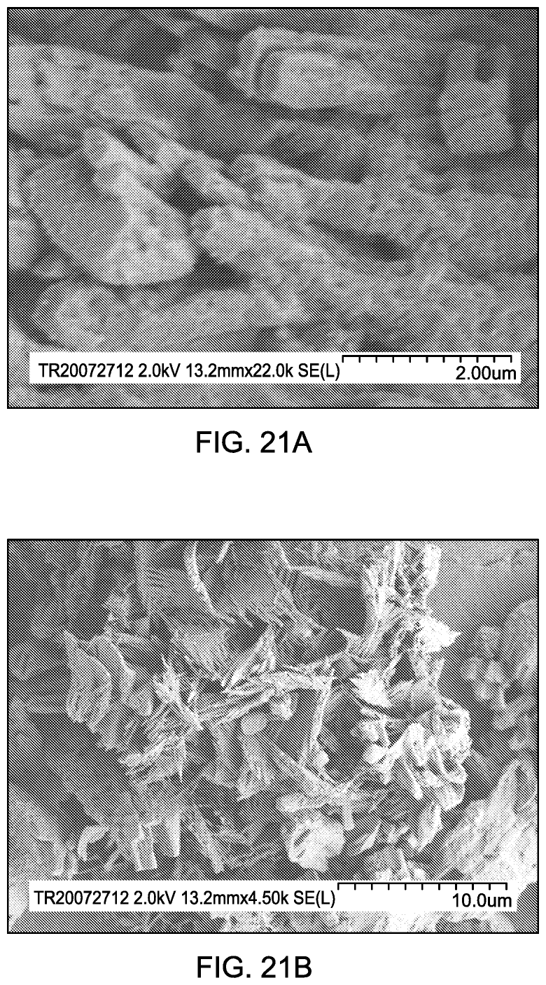

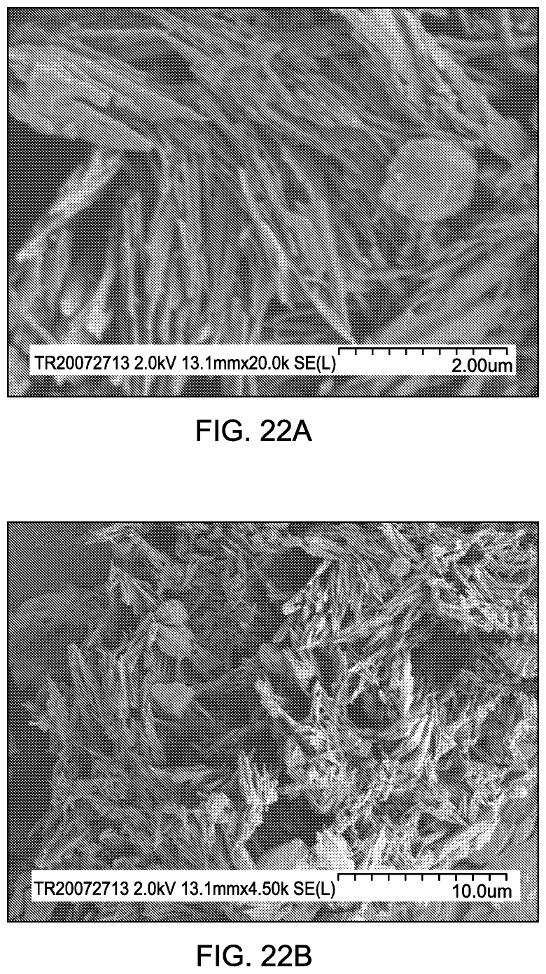

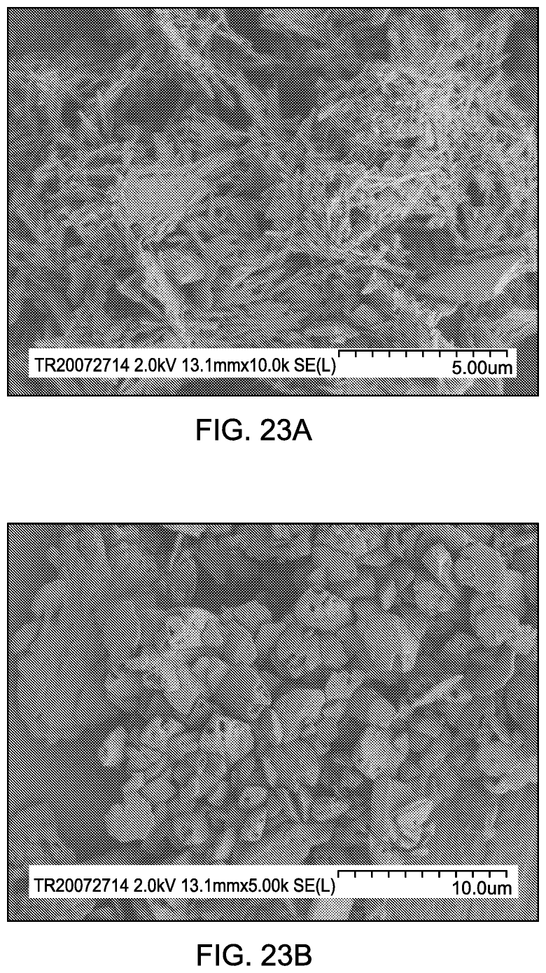

As shown in FIG. 18, powder x-ray diffraction analysis show a common phase is obtained, which is similar to that expected for Cu(Qc)₂. As shown in FIG. 19, thermogravimetric analysis data reveal a common decomposition temperature and consistent inorganic content in the samples. SEM images of FIG. 20A, FIG. 20B, FIG. 21A, FIG. 21B, FIG. 22A, FIG. 22B, FIG. 23A and FIG. 23B, show complex morphologies are obtained, progressing from reasonably well-defined intergrown capped geometric prisms to predominantly wire-like aggregates as a function of synthesis pH.

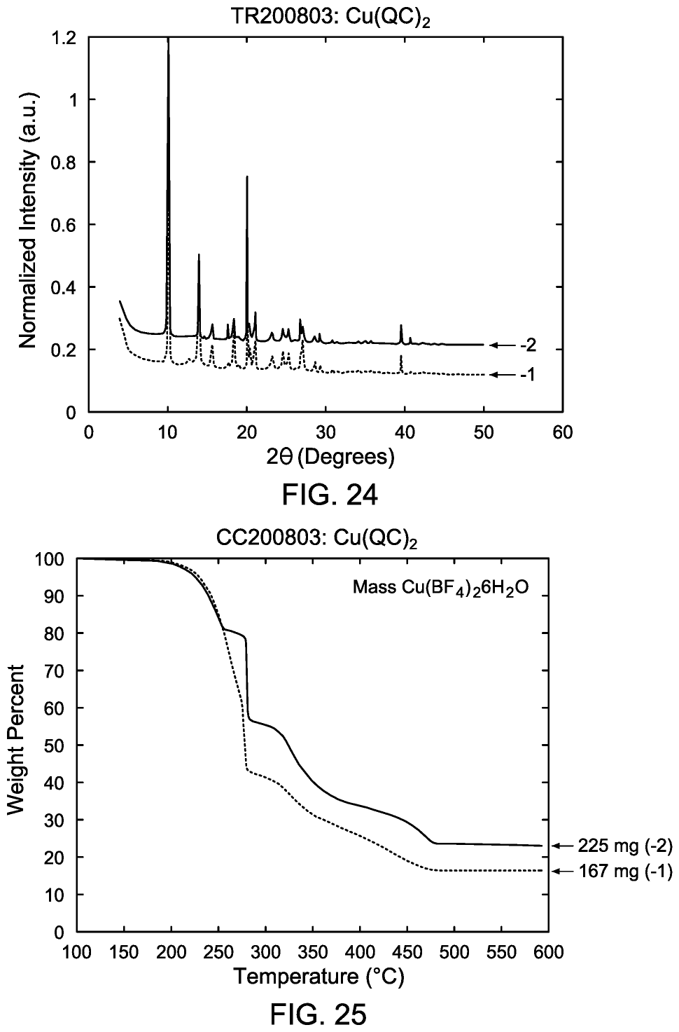

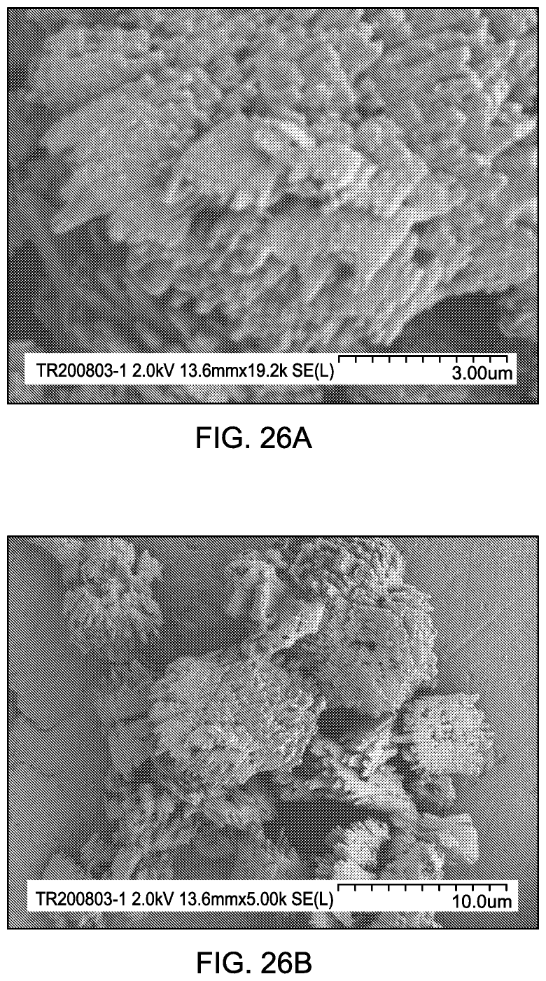

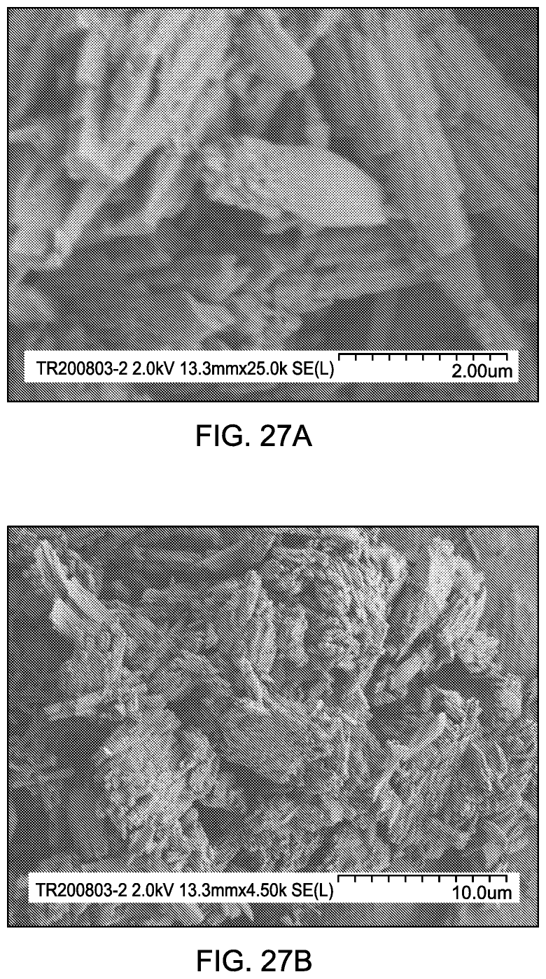

For the acetone/water syntheses, the conditions pursued are displayed in Table 6 below. Characterization data shown in FIG. 24, and FIG. 25, and SEM Images of the same in FIG. 26A, FIG. 26B, FIG. 27A and FIG. 27B. Sample 2 was performed at a higher metal content to test whether the initial preparation was to be performed with an anhydrous metal or hydrated metal, as the molar volume of Cu would differ. The results suggest the metal content is not a significant factor in the synthesis.

TABLE 6

| | Mass | Solvent | | |
|---|---|---|---|---|
| Sample | Cu(BF₄)₂•6H₂O | Composition | Na₂CO₃:NaHCO₃ | pH |
| −1 | 167 mg | 73% Acetone, | 80:20 | 12.83 |
| | | 27% Water | | |
| −2 | 225 mg (167 mg eq. | 73% Acetone, | 80:20 | 12.83 |
| | to anhyd form) | 27% Water | | |

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

Additionally or alternately, the invention relates to:

Embodiment 1: A method of making metal-organic frameworks comprising the steps of:
(a) mixing ethanol, at least one solvent, an acetate metal salt and quinoline-5-carboxylic acid to provide a synthesis solution, wherein the solvent is an organic solvent and the synthesis solution is non-aqueous having a concentration of at least 0.04 to 0.4 moles of quinolone-5-carboxylic acid per liter of the synthesis solution;
(b) heating the synthesis solution to a reaction temperature; and
(c) reducing the reaction temperature to produce a metal-organic framework material having a volumetric yield of at least about 50 percent by volume of metal-organic frameworks per liter of synthesis solution.

Embodiment 2: A method of making metal-organic frameworks comprising the steps of:
(a) providing a solvent composition comprising at least one solvent;
(b) combining the solvent composition with a plurality of solid reagents to provide a synthesis solution, wherein the plurality of solid reagents comprises an acetate metal salt and of at least 0.04 to 0.4 moles of quinolone-5-carboxylic acid per liter of the synthesis solution;
(c) heating the synthesis solution to a reaction temperature of at least 80° C. or above; and
(d) reducing the reaction temperature to produce a metal-organic framework material, wherein the metal organic framework material comprises about 75 molar percent metal-organic frameworks.

Embodiment 3: The method of making metal-organic frameworks of embodiment 2, wherein the solvent composition is non-aqueous.

Embodiment 4: The method of making metal-organic frameworks of embodiments 2 or 3, wherein the solvent is selected from dimethylformamide and/or tetrahydrofuran.

Embodiment 5: The method of making metal-organic frameworks of embodiments 1 or 2, wherein the concentration of the acetate metal salt in the synthesis solution is between about 0.16 and 0.24 mole per liter of solvent.

Embodiment 6: The method of making metal-organic frameworks of any one of the preceding embodiments, wherein the metal-organic frameworks have a solvent inclusion between about 9.0 to about 12.7 percent by volume.

Embodiment 7: A method of making metal-organic frameworks comprising the steps of:
(a) mixing ethanol, an acetate metal salt and quinoline-5-carboxylic acid to provide a synthesis solution, wherein the synthesis solution is non-aqueous having a concentration of at least 0.04 to 0.4 moles of quinolone-5-carboxylic acid per liter of the synthesis solution;
(b) heating the synthesis solution to a reaction temperature; and
(c) reducing the reaction temperature to produce a metal-organic framework material, wherein the metal organic framework material comprises a 75 molar percent yield of metal-organic frameworks per liter of synthesis solution.

Embodiment 8: The method of making metal-organic frameworks of any one of the preceding embodiments, wherein the synthesis solution is heated for at least about 24 to about 72 hours.

Embodiment 9: The method of making metal-organic frameworks of any one of the preceding embodiments, wherein the reaction temperature is reduced at a rate of between about 0.1 to about 10° C. per hour.

Embodiment 10: The method of making metal-organic frameworks of any one of the preceding embodiments, wherein the metal-organic framework material comprises MOF Cu(Qc)₂.

Embodiment 11: The method of making metal-organic frameworks of embodiment 10, wherein MOF Cu(Qc)₂ has adsorption maxima (max) at a wavelength of about 474 nanometers.

Embodiment 12: A metal-organic framework MOF Cu(Qc)₂ having an adsorption maxima (λmax) at a wavelength of about 474 nanometers, and a solvent inclusion between about 9.0 to about 12.7 percent by volume, wherein the metal-organic framework is made by a process comprising the steps of:
(a) mixing ethanol, dimethylformamide, copper acetate hydrate, and quinoline-5-carboxylic acid to provide a synthesis solution, wherein the synthesis solution having a concentration of about 0.04 moles of quinolone-5-carboxylic acid per liter of synthesis solution;
(b) heating the synthesis solution to a reaction temperature of at least 80° C.; and
(c) reducing the reaction temperature to produce a metal-organic framework material comprising at least 75 molar percent metal-organic frameworks MOF Cu(Qc)₂.

Embodiment 13: A method of making MOF Cu(Qc)₂ comprising the steps of:
(a) providing a solvent composition, wherein the solvent composition comprises less than about 30% volume water;
(b) combining the solvent composition with a buffer and a plurality of reagents to provide a synthesis solution, wherein the reagents comprise one or more metal salts and one or more linkers; and
(c) heating the synthesis solution to a reaction temperature of at least 85° C. or above for at least 4 hours to produce MOF Cu(Qc)₂.

Embodiment 14: The method of making MOF Cu(Qc)₂ of embodiment 13, wherein the metal salt is an acetate metal salt.

Embodiment 15: The method of making MOF Cu(Qc)₂ of embodiment 13, wherein the linker is quinolone-5-carboxylate.

Embodiment 16: The method of making MOF Cu(Qc)₂ of embodiment 13, wherein the buffer comprises a morpholine and a sulphonic acid bridged by an alkyl group.

Embodiment 17: The method of making MOF Cu(Qc)₂ of embodiment 13, wherein the buffer comprises a Brønsted acid and its conjugate base, or a Brønsted base and its conjugate acid.

Embodiment 18: The method of making MOF Cu(Qc)₂ of embodiment 13, wherein the buffer is a bicarbonate or sodium carbonate.

Embodiment 19: The method of making MOF Cu(Qc)₂ of embodiment 13, wherein the buffer is MOPS, Na MOPS or NaHCO₃.

Embodiment 20: The method of making MOF Cu(Qc)₂ of embodiments 13, 14, 15, 16, 17, 18, or 19, wherein the synthesis solution is heated between about 100° C. and about 160° C.

Embodiment 21: The method of making MOF Cu(Qc)₂ of embodiments 13, 14, 15, 16, 17, 18, 19, or 20, wherein the solvent composition comprises water, an alcohol and/or tetrahydrofuran.

Embodiment 22: The method of making MOF Cu(Qc)₂ of embodiment 21, wherein the alcohol is selected from n-propanol, iso-propanol, methanol, ethanol, n-butanol.

Embodiment 23: The method of making MOF Cu(Qc)₂ of embodiments 13, 14, 15, 16, 17, 18, 19, 20 or 21, wherein the solvent composition is selected by evaluation of Hansen solubility parameters.

Embodiment 24: The method of making MOF Cu(Qc)₂ of embodiments 13, 14, 15, 16, 17, 18, 19, 20, 21, 22, or 23, wherein the synthesis solution is heated in static, tumbling or stirred conditions.

Embodiment 25: The method of making MOF Cu(Qc)₂ of embodiment 13, wherein the solvent composition comprises water and acetone.

Embodiment 26: The method of any one of the preceding embodiments, wherein MOF Cu(Qc)₂ has a particle size between about 0.5 microns to about 755 microns.

Embodiment 27: The method of any one of the preceding embodiments, wherein MOF Cu(Qc)₂ has a BET surface area of about 200 to about 300 m²/gram.

Embodiment 28: The method of any one of the preceding embodiments, wherein MOF Cu(Qc)₂ has a CO₂ capacity of between about 40 and about 90 cubic centimeters per gram at 0.5 bar and 195° K.

Embodiment 29: The method of any one of the preceding embodiments, wherein MOF Cu(Qc)₂ has a CO₂ capacity of between about 60 cubic centimeters per gram at 0.5 bar and 195° K.

Embodiment 30: The method of any one of the preceding embodiments, wherein MOF Cu(Qc)₂ has an ethane adsorption capacity of between about 1.8 and about 2.6 millimole per gram at 303° K.

Embodiment 31: The method of any one of the preceding embodiments, wherein MOF Cu(Qc)₂ has an ethane adsorption capacity of between about 2.0 and about 2.4.

Embodiment 32: The method of any one of the preceding embodiments, further comprising the step of filtering the metal-organic framework material.

Embodiment 33: The method of any one of the preceding embodiments, further comprising the step of washing the metal-organic framework material.

Embodiment 34: The method of any one of the preceding embodiments, further comprising the step of triturating the metal-organic framework material in a solvent.

Embodiment 35: The method of any one of the preceding embodiments, wherein the steps of embodiments 28, 29, and 30 are repeated at least once.

Embodiment 36: The method of any one of the preceding embodiments, wherein the metal-organic framework produces powder x-ray diffraction peaks at 20 values between about 10° and about 15° and between about 25° and about 30° for the metal-organic framework Cu(Qc)₂ that has been dried.

Embodiment 37: The method of any one of the preceding embodiments, wherein MOF Cu(Qc)₂ produces powder x-ray diffraction peaks at 20 values which are equal to a metal-organic framework Cu(Qc)₂ produced by a traditional synthesis.

1-37. (canceled)

38. A method of making metal-organic frameworks comprising the steps of:
mixing ethanol, at least one solvent, an acetate metal salt and quinoline-5-carboxylic acid to provide a synthesis solution, wherein the solvent is an organic solvent and the synthesis solution is non-aqueous having a concentration of at least 0.04 to 0.4 moles of quinolone-5-carboxylic acid per liter of the synthesis solution;
heating the synthesis solution to a reaction temperature; and
reducing the reaction temperature to produce a metal-organic framework material having a volumetric yield of at least about 50 percent by volume of metal-organic frameworks per liter of synthesis solution.

39. A method of making metal-organic frameworks comprising the steps of:
providing a solvent composition comprising at least one solvent;
combining the solvent composition with a plurality of solid reagents to provide a synthesis solution, wherein the plurality of solid reagents comprises an acetate metal salt and at least 0.04 to 0.4 moles of quinolone-5-carboxylic acid per liter of the synthesis solution;
heating the synthesis solution to a reaction temperature of at least 80° C. or above; and
reducing the reaction temperature to produce a metal-organic framework material, wherein the metal organic framework material comprises about 75 molar percent metal-organic frameworks.

40. The method of making metal-organic frameworks of claim 39 wherein the solvent composition is non-aqueous.

41. The method of making metal-organic frameworks of claim 39, wherein the solvent is selected from dimethylformamide and/or tetrahydrofuran.

42. The method of making metal-organic frameworks of claim 39, wherein the concentration of the acetate metal salt in the synthesis solution is between about 0.16 and 0.24 mole per liter of solvent.

43. A method of making metal-organic frameworks comprising the steps of:
mixing ethanol, an acetate metal salt and quinoline-5-carboxylic acid to provide a synthesis solution, wherein the synthesis solution is non-aqueous having a concentration of at least 0.04 to 0.4 moles of quinolone-5-carboxylic acid per liter of the synthesis solution;
heating the synthesis solution to a reaction temperature; and
reducing the reaction temperature to produce a metal-organic framework material, wherein the metal organic framework material comprises a 75 molar percent yield of metal-organic frameworks per liter of synthesis solution.

44. The method of making metal-organic frameworks of claim 38, wherein the synthesis solution is heated for at least about 24 to about 72 hours and wherein the reaction temperature is reduced at a rate of between about 0.1 to about 10° C. per hour.

45. The method of making metal-organic frameworks of claim 39, wherein the synthesis solution is heated for at least about 24 to about 72 hours and wherein the reaction temperature is reduced at a rate of between about 0.1 to about 10° C. per hour.

46. The method of making metal-organic frameworks of claim 44, wherein the synthesis solution is heated for at least about 24 to about 72 hours and wherein the reaction temperature is reduced at a rate of between about 0.1 to about 10° C. per hour.

47. The method of making metal-organic frameworks of claim 38, wherein the metal-organic framework material comprises MOF Cu(Qc)₂, wherein Qc is quinolone-5-carboxylate.

48. The method of making metal-organic frameworks of claim 39, wherein the metal-organic framework material comprises MOF Cu(Qc)₂, wherein Qc is quinolone-5-carboxylate.

49. The method of making metal-organic frameworks of claim 44, wherein the metal-organic framework material comprises MOF Cu(Qc)₂, wherein Qc is quinolone-5-carboxylate.

50. A metal-organic framework MOF Cu(Qc)₂, wherein Qc is quinolone-5-carboxylate, having an adsorption maxima (λmax) at a wavelength of about 474 nanometers, and a solvent inclusion between about 9.0 to about 12.7 percent by volume, wherein the metal-organic framework is made by a process comprising the steps of:
mixing ethanol, dimethylformamide, copper acetate hydrate, and quinoline-5-carboxylic acid to provide a synthesis solution, wherein the synthesis solution having a concentration of about 0.04 moles of quinolone-5-carboxylic acid per liter of synthesis solution;
heating the synthesis solution to a reaction temperature of at least 80° C.; and reducing the reaction temperature to produce a metal-organic framework material comprising at least 75 molar percent metal-organic frameworks MOF Cu(Qc)₂.

51. A method of making MOF Cu(Qc)₂, wherein Qc is quinolone-5-carboxylate, comprising the steps of:
providing a solvent composition, wherein the solvent composition comprises less than about 30% volume water;
combining the solvent composition with a buffer and a plurality of reagents to provide a synthesis solution, wherein the reagents comprise one or more metal salts and one or more linkers; and
heating the synthesis solution to a reaction temperature of at least 85° C. or above for at least 4 hours to produce MOF Cu(Qc)₂.

52. The method of making MOF Cu(Qc)₂ of claim 51, wherein the metal salt is an acetate metal salt.

53. The method of making MOF Cu(Qc)₂ of claim 51, wherein the buffer comprises a morpholine and a sulphonic acid bridged by an alkyl group.

54. The method of making MOF Cu(Qc)₂ of claim 51, wherein the buffer comprises a Brønsted acid and its conjugate base, or a Brønsted base and its conjugate acid.

55. The method of making MOF Cu(Qc)₂ of claim 51, wherein the buffer is a bicarbonate or sodium carbonate.

56. The method of making MOF Cu(Qc)₂ of claim 51, wherein the synthesis solution is heated between about 100° C. and about 160° C.

57. The method of making MOF Cu(Qc)₂ of claim 51, wherein the solvent composition comprises water, an alcohol and/or tetrahydrofuran.

58. The method of making MOF Cu(Qc)₂ of claim 57, wherein the alcohol is selected from n-propanol, iso-propanol, methanol, ethanol, n-butanol.

59. The method of making MOF Cu(Qc)₂ of claim 51, wherein the solvent composition is selected by evaluation of Hansen solubility parameters.

60. The method of making MOF Cu(Qc)₂ of claim 51, wherein the solvent composition comprises water and acetone.

61. The method of claim 51, further comprising at least one of the step of filtering the metal-organic framework material, the step of washing the metal-organic framework material, and the step of triturating the metal-organic framework material in a solvent.

62. The method of claim 61, wherein the steps of claim 61 are repeated at least once.
